(19) United States
(12) Patent Application Publication
(10) Pub. No.: US 2025/0097097 A1
(43) Pub. Date: Mar. 20, 2025

(54) DEVICES AND METHODS FOR COMMUNICATION IN A WIRELESS COMMUNICATION NETWORK

(71) Applicant: Huawei Technologies Co., Ltd., Shenzhen (CN)

(72) Inventors: Zhongfeng Li, Shanghai (CN); Richard Stirling-Gallacher, Munich (DE); Jian Luo, Shenzhen (CN); Yilin Li, Shenzhen (CN); Jian Li, Shanghai (CN)

(21) Appl. No.: 18/944,802

(22) Filed: Nov. 12, 2024

Related U.S. Application Data
(63) Continuation of application No. 17/207,367, filed on Mar. 19, 2021.
(63) Continuation of application No. PCT/EP2018/076751, filed on Oct. 2, 2018.

(30) Foreign Application Priority Data
Sep. 20, 2018 (WO) PCT/EP2018/075525

(51) Int. Cl. H04L 41/0668; H04B 7/06; H04B 7/08; H04L 41/0677; H04W 4/40; H04W 24/08; H04W 72/04; H04W 76/19

(52) U.S. Cl. CPC H04L 41/0668; H04B 7/0617; H04B 7/0695; H04B 7/088; H04L 41/0677; H04W 24/08; H04W 72/04; H04W 76/19; H04W 4/40

(57) ABSTRACT

The application relates to a user equipment configured to communicate using a first signal or channel via a first resource with a first device and using a second signal or channel via a second resource with a second device. The user equipment is configured to: measure the first signal or channel in the first resource for a beam or link failure detection; and, in response to a detected failure in the first resource, transmit the second signal or channel via the second resource to the second device for a failure recovery request. The first device can be a further user equipment and the second device can be a base station, wherein the first resource is a sidelink resource between the user equipment and the further user equipment and the second resource is an uplink resource between the user equipment and the base station.

### CROSS-REFERENCE TO RELATED APPLICATIONS

This application is a continuation of U.S. patent application Ser. No. 17/207,367, filed on Mar. 19, 2021, which is a continuation of International Application No. PCT/EP2018/076751, filed on Oct. 2, 2018, which claims priority to International Patent Application No. PCT/EP2018/075525, filed on Sep. 20, 2018. All of the afore-mentioned patent applications are hereby incorporated by reference in their entireties.

### TECHNICAL FIELD

In general, the present invention relates to wireless communication networks. More specifically, the present invention relates to devices and methods for communication in a wireless communication network.

### BACKGROUND

There is a need for capable V2X (Vehicle to Vehicle, vehicle to infrastructure, vehicle to network, vehicle to pedestrian) or cellular intelligent transportation system (C-ITS) communication systems to support the increasing need for vehicle safety, traffic management and the different levels of assistance for automated driving. There is also a need for wireless communication introduced to support industry automation (also referred to as industry 4.0). Both V2X and industry 4.0 require low latency and high reliable traffic transmission. To this end several technical problems need to be addressed, including the problem of a fast recovery, in case of a radio link or beam failure.

Currently there are proposals for beam failure recovery, when there is only a single Uu link. From these proposals it is not clear how to perform a sidelink beam failure recovery, when a sidelink is introduced, considering, in particular, that the sidelink may be centrally controlled/scheduled by a gNB/RSU/access point (AP)/relay node (RN) via the Uu link or sidelink or Un link. Furthermore, it has to be addressed: how to utilize the Uu/Un link for SL beam recovery; and/or how to utilize a 1st SL for a 2nd SL beam recovery; and/or how to utilize a SL for Uu/Un link beam recovery.

For the traditional single hop transmission, that is Uu link based transmission, a beam failure (or called beam radio link failure) recovery procedure has been proposed in NR for fast beam recovery, which avoids the long delays associated with a radio link failure (or called cell radio link failure) which has long delay. However, as already mentioned, only a single hop or single Uu link transmission beam failure recovery is considered, which is discussed in more detail in the following.

The beam failure procedure may trigger a new identified beam from the same serving cell gNB or a different gNB. The conventional UE beam failure recovery includes the following stages: (1) beam failure detection; (2) new candidate beam identification; (3) beam failure recovery request, BFRQ, transmission; and (4) UE monitors gNB response to beam failure recovery request.

For a beam failure detection, i.e. above stage (1), UE monitors the signal resource set q̅₀ to assess if a beam failure trigger condition has been met, wherein the beam failure detection signal includes a periodic CSIRS and/or SS/PBCH block. The beam failure means that the radio link quality for all corresponding resource configurations in the set q̅₀ that the UE uses to assess the radio link quality is worse, i.e. smaller than certain threshold Q_{out,LR}.

For the new candidate beam identification, i.e. above stage (2), the UE monitors beam identification RS to find a new candidate beam. The beam identification RS includes a periodic CSIRS and/or SS/PBCH block. A UE can be provided, for a serving cell, a set q̅₁ of periodic CSI-RS resource configuration indexes and/or SS/PBCH block indexes by a higher layer parameter referred to as candidateBeamRSList for radio link quality measurements on the serving cell. The UE provides the periodic CSI-RS configuration indexes and/or SS/PBCH block indexes from the set Q and the corresponding L1-RSRP measurements that are larger than or equal to the corresponding thresholds.

For beam failure recovery request transmission, i.e. above stage (3), if SS-RSRP or CSI-RS RSRP in the candidateBeamRSList is above a certain configured threshold, the configured or corresponding random access preamble is selected for the beam failure recovery request.

For the monitoring of the gNB response to the beam failure recovery request by the UE, i.e. above stage (4), the PRACH for the beam failure recovery request is transmitted in slot n and the UE will monitor the response PDCCH starting from n+4 within a configured window. The UE assumes the same antenna port quasi-collocation parameters with the selected periodic CSIRS or SS/PBCH block for the response PDCCH monitoring.

As already mentioned above, the conventional beam failure recovery procedure described above applies to the Uu link. Thus, there is still a need for a sidelink beam failure recovery, considering, in particular, that the sidelink may be centrally controlled/scheduled by gNB/RSU/access point (AP)/relay node (RN) via the Uu link or sidelink or Un link. Furthermore, it has to be addressed: how to utilize Uu/Un link for SL beam recovery; and/or how to utilize a 1st SL for a 2nd SL beam recovery; and/or how to utilize a SL for Uu/Un link beam recovery.

Thus, there is a need for improved devices and methods for a wireless communication network addressing one or more of the problems mentioned above.

### SUMMARY

It is an object of the invention to provide improved devices and methods for a wireless communication network.

The foregoing and other objects are achieved by the subject matter of the independent claims. Further implementation forms are apparent from the dependent claims, the description and the figures.

In order to describe the different aspects of the invention in more detail, the following terms, abbreviations and notations will be used in the following:
UE User Equipment
BS Base Station, gNodeB, eNodeB, roadside unit and the like
V2V Vehicle to vehicle
V2X Vehicle to everything
C-ITS Cellular Intelligent Transportation System
NR New Radio
SL Sidelink
DL Downlink
UL Uplink
DCI Downlink Control Information
PBCH Physical Broadcast Channel
PDCCH Physical Downlink Control Channel
PUCCH Physical Uplink Control Channel
QCL Quasi-Co-Location
SS Synchronization Signal
RS Reference Signal
CSI Channel State Information
CSIRS CSI Reference Signal
SRS Sounding Reference Signal
CS-RNTI Configured Scheduling RNTI
SSB SS/PBCH block, Synchronization Signal/Physical broadcast channel
BFRQ Beam failure recovery request
BFRR Beam failure recovery response

According to a first aspect the invention relates to a user equipment configured to communicate using a first signal and/or channel via a first resource with a first device and using a second signal and/or channel via a second resource with a second device. The user equipment is configured to: measure the first signal and/or channel in the first resource for a beam or link failure detection; and, in response to a detected failure in the first resource, transmit the second signal and/or channel via the second resource to the second device for a failure recovery request.

In a further possible implementation form of the first aspect, the first device can be a further user equipment and the second device can be a base station, wherein the first resource is a sidelink resource between the user equipment and the further user equipment and the second resource is an uplink resource between the user equipment and the base station.

In a further possible implementation form of the first aspect, the first device can be a base station and the second device can be a further user equipment, wherein the first resource is a downlink resource between the user equipment and the base station and the second resource is a sidelink resource between the user equipment and the further user equipment.

In a further possible implementation form of the first aspect, the user equipment is configured to detect a beam failure or link failure to have occurred, in case a radio link quality is smaller than a first threshold value and/or there is one or more error occurred for the channel detection.

In a further possible implementation form of the first aspect, the radio link quality is the signal strength of one or more reference signals, RS, and/or SSBs. And/or the detected channel is control channel and/or data channel.

In a further possible implementation form of the first aspect, the user equipment is further configured to, in response to a detected failure in the first resource, determine a new signal resource and/or a new beam for communicating with the first device, in particular on the basis of one or more reference signals and/or SSB in the first set or in a second set received from the first device.

In a further possible implementation form of the first aspect, the user equipment is configured to determine the new beam or new signal resource for communicating with the first device by comparing a signal strength of the one or more reference signals and/or SSB with a second threshold signal strength.

In a further possible implementation form of the first aspect, the user equipment is configured to transmit the second signal and/or channel or in case the user equipment is not able to determine a new beam or new signal resource for communicating with the first device, the second signal or channel provides an indication that no new beam or new signal resource for communicating with the first device has been determined, or an indication that a new beam or new signal resource is required and/or an indication that a beam sweeping is required or an indication that beam failure occurs.

In a further possible implementation form of the first aspect, in case the user equipment is able to determine a new beam or new signal resource for communicating with the first device, the second signal or channel provides an indication about the new beam or new signal resource determined by the user equipment.

In a further possible implementation form of the first aspect, the user equipment is further configured to receive, in response to the transmission of the failure recovery request, in particular a beam failure recovery request; BFRQ, based on the second signal and/or channel, a failure recovery response or a recovery response, in particular a beam failure recovery response, BFRR.

In a further possible implementation form of the first aspect, the user equipment is further configured to monitor the failure recovery response or recovery response, in particular BFRR, in different search space and/or different CORESET, assumes the same antenna port quasi-collocation parameters respectively with the more than one indicated RS and/or SSB by the second signal or channel via the second resource. In other words, for PDCCH monitoring and/or for a corresponding PDSCH reception, the user equipment can assume the same antenna port quasi-collocation parameters with the indicated RS or SSB by the second signal or channel. For PDCCH monitoring and/or for a corresponding PDSCH reception in a different search space and/or different CORESET, the user equipment can assume the same antenna port quasi-collocation parameters respectively with the more than one indicated RS or SSB.

In a further possible implementation form of the first aspect, the user equipment is configured to select the second resource for the second signal or channel based on the first resource for the first signal or channel and a correspondence and/or mapping between the first resource and the second resources. The correspondence and/or mapping can be predefined and/or received by the user equipment via a signaling indicating the correspondence between the resource for the first signal/channel and the resource for the second signal/channel.

In a further possible implementation form of the first aspect, the first device is the base station and the second device is the further user equipment, wherein the failure recovery request is configured to trigger the further user equipment to transmit and/or forward the failure recovery request to the base station.

In a further possible implementation form of the first aspect, the first resource is a downlink resource between the user equipment and the base station, wherein the user equipment is further configured to transmit a further failure recovery request to the base station via the uplink resource between the user equipment and the base station.

In a further possible implementation form of the first aspect, the failure recovery request is configured to trigger the further user equipment to transmit or forward the failure recovery request to a third user equipment for transmitting or forwarding the failure recovery request to the base station.

In a further possible implementation form of the first aspect, the first device is the further user equipment and the second device is the base station, wherein the beam or link failure is a beam or link failure of the sidelink, wherein the user equipment is further configured to transmit the failure recovery request via the Uu uplink resource or sidelink resource to the base station.

In a further possible implementation form of the first aspect, the first device is the further user equipment and the second device is the base station, wherein the beam or link failure is a beam or link failure of the sidelink resource in a downlink direction or in one direction, wherein the user equipment is further configured to transmit a further failure recovery request via the sidelink resource in an uplink direction or in a reverse direction to the further user equipment.

In a further possible implementation form of the first aspect, the further failure recovery request is configured to trigger the further user equipment to transmit or forward the further failure recovery request to the base station via a third resource, in particular a third communication link between the further user equipment and the base station.

In a further possible implementation form of the first aspect, the further failure recovery request is configured to trigger the further user equipment to forward the further failure recovery request to the base station via the third resource based on a predefined and/or preconfigured correspondence or mapping between the sidelink resource in the uplink direction or in the reverse direction and the third resource.

In a further possible implementation form of the first aspect, the failure recovery request is configured to trigger the further user equipment to forward the failure recovery request to a third user equipment for forwarding the failure recovery request to the base station.

According to a second aspect the invention relates to a communication network comprising a user equipment according to the first aspect of the invention, at least one further user equipment and a base station.

According to a third aspect the invention relates to a method of operating a user equipment configured to communicate using a first signal and/or channel via a first resource with a first device and using a second signal and/or channel via a second resource with a second device. The method comprises the operations of: measuring the first signal and/or channel in the first resource for a beam or link failure detection; and, in response to a detected failure in the first resource, transmitting the second signal or channel via the second resource to the second device for a failure recovery request.

In a further possible implementation form of the third aspect, the first device can be a further user equipment and the second device can be a base station, wherein the first resource is a sidelink resource between the user equipment and the further user equipment and the second resource is an uplink resource between the user equipment and the base station.

In a further possible implementation form of the third aspect, the first device can be a base station and the second device can be a further user equipment, wherein the first resource is a downlink resource between the user equipment and the base station and the second resource is a sidelink resource between the user equipment and the further user equipment.

The method according to the third aspect of the invention can be performed by the user equipment according to the first aspect of the invention. Further features of the method according to the third aspect of the application result directly from the functionality of the user equipment according to the first aspect of the application and its different implementation forms described above and below.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the application are described in more detail with reference to the attached figures and drawings, in which:

FIGS. 1a and 1b are schematic diagrams showing a wireless communication network, including a user equipment according to an embodiment in an in-coverage scenario and a partial coverage scenario;

FIGS. 2a-d are schematic diagrams showing a wireless communication network, including a user equipment according to an embodiment for a recovery of a SL failure in an in-coverage scenario and a partial coverage scenario;

FIGS. 3a and 3b are schematic diagrams showing a wireless communication network, including a user equipment according to an embodiment for a recovery of a SL failure in a downlink direction in an in-coverage scenario and a partial coverage scenario;

FIGS. 4a and 4b are schematic diagrams showing a wireless communication network, including a user equipment according to an embodiment for a recovery of a SL failure in an uplink direction in an in-coverage scenario and a partial coverage scenario;

FIGS. 5a and 5b are schematic diagrams showing a wireless communication network, including a user equipment according to an embodiment for a recovery of an Uu link failure in a downlink direction and/or sidelink in one direction in an in-coverage scenario and a partial coverage scenario;

FIGS. 6a and 6b are schematic diagrams showing a wireless communication network, including a user equipment according to an embodiment for a multi-hop recovery of an Uu link and/or sidelink failure in a downlink direction or in one sidelink direction in an in-coverage scenario and a partial coverage scenario; and

FIG. 7 is a flow diagram illustrating operations of a method of operating a user equipment according to an embodiment.

In the following identical reference signs refer to identical or at least functionally equivalent features.

### DETAILED DESCRIPTION OF ILLUSTRATIVE EMBODIMENTS

In the following description, reference is made to the accompanying figures, which form part of the disclosure, and which show, by way of illustration, specific aspects of embodiments of the application or specific aspects in which embodiments of the present application may be used. It is understood that embodiments of the application may be used in other aspects and comprise structural or logical changes not depicted in the figures. The following detailed description, therefore, is not to be taken in a limiting sense, and the scope of the present application is defined by the appended claims.

For instance, it is understood that a disclosure in connection with a described method may also hold true for a corresponding device or system configured to perform the method and vice versa. For example, if one or a plurality of specific method operations are described, a corresponding device may include one or a plurality of units, e.g. functional units, to perform the described one or plurality of method operations (e.g. one unit performing the one or plurality of operations, or a plurality of units each performing one or more of the plurality of operations), even if such one or more units are not explicitly described or illustrated in the figures. On the other hand, for example, if a specific apparatus is described based on one or a plurality of units, e.g. functional units, a corresponding method may include one operation to perform the functionality of the one or plurality of units (e.g. one operation performing the functionality of the one or plurality of units, or a plurality of operations each performing the functionality of one or more of the plurality of units), even if such one or plurality of operations are not explicitly described or illustrated in the figures. Further, it is understood that the features of the various exemplary embodiments and/or aspects described herein may be combined with each other, unless specifically noted otherwise.

The methods, devices and systems described herein may particularly be implemented in wireless communication networks based on 5G New Radio (NR) mobile communication standards and beyond.

Likewise, the methods, devices and systems described herein may also be implemented in wireless communication networks based on mobile communication standards such as LTE, in particular 3G, 4G, 4.5G, and 5G. The methods, devices and systems described herein may also be implemented in wireless communication networks, in particular communication networks similar to WiFi communication standards according to IEEE 802.11. The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

The devices described herein may be configured to transmit and/or receive radio signals. Radio signals may be or may include radio frequency signals radiated by a radio transmitting device (or radio transmitter or sender). However, devices described herein are not limited to transmit and/or receive radio signals, also other signals designed for transmission in deterministic communication networks may be transmitted and/or received.

The devices and systems described herein may include processors or processing devices, memories and transceivers, i.e. transmitters and/or receivers. In the following description, the term “processor” or “processing device” describes any device that can be utilized for processing specific tasks (or blocks or operations). A processor or processing device can be a single processor or a multi-core processor or can include a set of processors or can include means for processing. A processor or processing device can process software or firmware or applications etc.

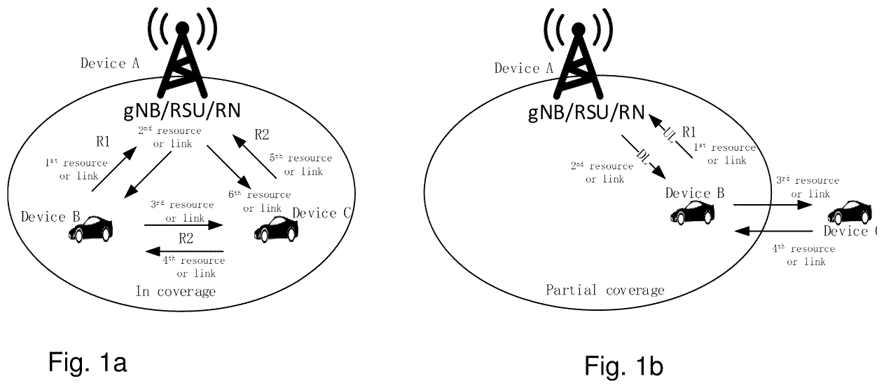

FIGS. 1a and 1b are schematic diagrams showing a wireless communication network 100 in an in coverage scenario (FIG. 1a) and a partial coverage scenario (FIG. 1b). In an embodiment, the wireless communication network 100 can be implemented as a network according to the 5G standard or a standard based thereon. In the exemplary embodiment shown in FIGS. 1a and 1b, the wireless communication network 100 comprises a first user equipment (UE) 101, a second user equipment (UE) 103 and a base station 105.

Although in FIGS. 1a and 1b the user equipments 101, 103 are illustrated as vehicular UEs, the person skilled in the art will appreciate that embodiments of the application apply to any type of user equipments 101 and 103 configured to communicate via an UL and DL with a base station or via a SL with base station and via a SL with each other, such as user equipments implemented in industry 4.0 scenarios. As used herein, the term “base station” applies to any type of network entity configured to communicate with user equipments via the air interface, such as a gNB, access point, TRP, RSU, relay, UE, and the like.

As will be described in more detail below, the first user equipment 101 is configured to communicate using a first signal and/or channel via a first resource with a first device and using a second signal and/or channel via a second resource with a second device. The user equipment 101 is configured to: measure the first signal and/or channel in the first resource for a beam or link failure detection; and, in response to a detected failure in the first resource, transmit the second signal and/or channel via the second resource to the second device for a failure recovery request or a failure indication. Usually both beam failure and link failure are based on the radio link quality monitoring. The link failure can be cell link failure based on cell radio link monitoring which is usually involved with longer time for monitoring and signal strength average are performed. The link failure can also be based on short term radio link quality monitoring with certain RS/channel configuration. For example, for industry 4.0 scenario, even without beam based transmission, fast link failure request still preferred for the low latency and high reliability transmission requirement. While beam failure detection is also based on radio link monitoring but usually based on the RS/channel with beam based transmission.

In an embodiment, the first device can be the second or further user equipment 103 and the second device can be the base station 105, wherein the first resource is a sidelink resource between the first user equipment 101 and the further user equipment 103 and the second resource is an uplink resource or a sidelink resource between the first user equipment 101 and the base station 105.

In an embodiment, the first device can be the base station 105 and the second device can be the second or further user equipment 103, wherein the first resource is a downlink resource between the user equipment 101 and the base station 105 or a sidelink resource between and the second resource is a sidelink resource between the user equipment 101 and the further user equipment 103.

Further embodiments of the first user equipment 101 will be described in the following. As will be appreciated from the following, embodiments of the application provide (a) a single SL hop beam failure recovery, (b) a Uu link beam failure recovery via SL, and (c) more than one SL hop beam failure recovery.

In the following detailed description of further embodiments of the application the link(s) and/or resource(s) and/or signal(s) and/or channel(s) are denoted in the following way, as illustrated in FIGS. 1a and 1b.

The first resource or link can be denoted as: device B transmitted link and/or resource and/or signal and/or channel; or device B to device A link; or device A received link and/or resource and/or signal and/or channel.

The second resource or link can be denoted as: device B received link and/or resource and/or signal and/or channel; or device A to device B link; or device A transmitted link and/or resource and/or signal and/or channel.

The third resource or link can be denoted as: device B transmitted link and/or resource and/or signal and/or channel; or device B to device C link; or device C received link and/or resource and/or signal and/or channel.

The fourth resource or link can be denoted as: device B received link and/or resource and/or signal and/or channel; or device C to device B link; or device C transmitted link and/or resource and/or signal and/or channel.

The fifth resource or link can be denoted as: device C transmitted link and/or resource and/or signal and/or channel; or device C to device A link; or device A received link and/or resource and/or signal and/or channel.

The sixth resource or link can be denoted as: device C received link and/or resource and/or signal and/or channel; or device A to device C link; or device A transmitted link and/or resource and/or signal and/or channel.

As already mentioned above, embodiments of the application provide a single SL hop beam failure recovery. According to embodiments of the application single SL hop beam failure recovery can comprise the following four operations or stages.

A first stage of the single SL hop beam failure recovery implemented by embodiments of the application is related to the SL beam failure detection by the UE ioi based on SL signal. The detected SL signal can be in either one of the SL direction or both SL directions. The SL signal and/or channel can include RS and/or SSB and/or preamble and/or SL control channel and/or SL data channel.

A threshold can be configured for the SL beam failure detection with respect to the SL channel quality. If all the measured signals in one set have a quality lower than the configured threshold, then a beam or link failure occurs. Or if one or more than one error occur or the error is higher than certain configured threshold based on a channel (control or data channel) detection, then a link failure occurs. The measured signals or channel in one set can be in either one of the SL direction or both SL directions. If there are two SL directions for beam or link failure detection, one threshold can be configured for the low signaling overhead. Alternatively, separate thresholds can be configured. The latter case may be helpful for different channel conditions e.g. interference.

A second stage of the single SL hop beam failure recovery implemented by embodiments of the application is related to a new SL candidate beam identification by the UE 101 based on the SL signal and/or channel. In an embodiment, a threshold can be configured for the identification of a new SL candidate beam, which can be used after a beam failure has occurred. The SL signal and/or channel for the new SL candidate beam can be in either one of the SL directions or in both SL directions. The SL signal and/or channel can include RS and/or SSB and/or preamble and/or SL control channel and/or SL data channel.

There can be two modes for the new SL candidate beam identification based on the SL signal and/or channel, namely mode 1 and mode 2.

Mode 1 concerns the case that no new qualified beam can be found. In an embodiment, the UE 101 is configured to generate and transmit a report message that no new qualified beam could be found, that a new beam transmission is required and/or that a beam sweeping is required or beam or link failure occurs. Such a reporting can be mapped to a dedicated resource/RS or can be transmitted as control or data channel contents. According to embodiments of the application, the report can be transmitted with a mapping to Uu/Un/another SL dedicated resources/RS and/or the opposite link resources/RS and/or another Uu/Un/SL resources/RS. According to embodiments of the application, mode 1 can also apply to the Uu link.

Mode 2 concerns the case that a new qualified beam has been found. According to embodiments of the application, in this case the BFRQ transmission is initiated, which is described in more detail below in the context of the third stage.

A third stage of the single SL hop beam failure recovery implemented by embodiments of the application is related to the transmission of one or more SL beam failure recovery requests, by the UE 101 in the Uu/Un link or in the SL or a combination thereof.

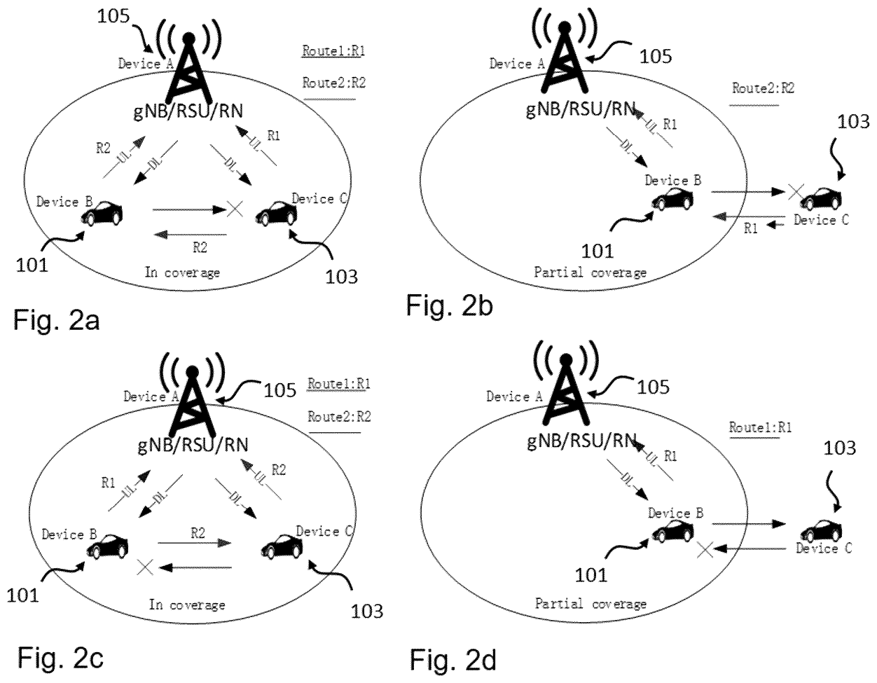

A first case, i.e. case 1, concerns the SL BFRQ being transmitted in the 1st Uu/Un link (or the 1st SL), which will be described in the following in more detail under reference to FIGS. 2a and 2c (for an in coverage scenario) and FIG. 2d (for a partial coverage scenario). In the figures the BFRQ transmission route for this case is identified as R1. To enable a fast SL beam failure recovery, according to embodiments of the application RS in device_BtoC and channel resource/RS in device_CtoA mapping or correspondence or device_CtoB and channel resource/RS in device_BtoA can be configured or signaled or defined, in particular a mapping or correspondence between a SL new candidate RS and Uu/Un (or another SL) dedicated resource e.g. PRACH or RS; and/or a mapping or correspondence between a SL new candidate RS and Uu/Un DL RS/SSB (or another SL RS/SSB).

A second case, i.e. case 2, concerns the SL BFRQ being transmitted first in the opposite SL, and then being transmitted in the 2nd Uu/Un link (or the 2nd SL), which will be described in the following in more detail under reference to FIGS. 2a and 2c (for an in coverage scenario) and FIG. 2b (for a partial coverage scenario). In the figures the BFRQ transmission route for this case is identified as R2. To enable a fast and reliable SL beam failure recovery, according to embodiments of the application RS in device_BtoC, channel resource/RS in device_CtoB and channel resource/RS in device_BtoA mapping or correspondence can be configured or signaled or defined, in particular a mapping or correspondence between SL RS and the opposite SL dedicate resource/RS, a mapping or correspondence between SL dedicated resource/RS and Uu/Un (or another SL) dedicated resource e.g. PRACH or RS, and/or a mapping or correspondence between SL dedicated resource/RS and Uu/Un (or another SL) DL RS/SSB.

According to embodiments of the application, a third case, i.e. case 3, can be a combination of the case 1 and case 2 described above. Supporting both case 1 and case 2 can be configured.

A fourth case, i.e. case 4, concerns the SL BFRQ information being transmitted by the UE 101 via control channel or a data channel.

According to an embodiment, the SL BFRQ information can be transmitted by the UE 101 via a control channel or data channel in the 1st Uu/Un link or the 1st SL, as illustrated in FIGS. 2a and 2c (for an in coverage scenario) and FIG. 2d (for a partial coverage scenario). In the figures the BFRQ transmission route for this case is identified as R1. To enable a fast SL beam failure recovery, the transmission resource/channel in Uu/Un or 2nd SL can be configured or signaled or defined, in particular a configuration of the transmission resource e.g. PUCCH or PUSCH for a SL new candidate RS reporting and/or beam failure indication/recovery request and/or link failure indication/recovery request.

According to an embodiment, the SL BFRQ can be first transmitted in the opposite SL via resource mapping, and then be transmitted in the 2nd Uu/Un link (or the 2nd SL) via a control channel or a data channel, as illustrated in FIGS. 2a and 2c (for an in coverage scenario) and FIG. 2b (for a partial coverage scenario). In the figures the BFRQ transmission route for this case is identified as R2. To enable a fast and reliable SL beam failure recovery, RS in device_BtoC, channel resource/RS in device_CtoB and channel resource/RS in device_BtoA can be configured or signaled or defined, in particular a mapping or correspondence between SL RS and the opposite SL dedicate resource/RS and/or the PUCCH or PUSCH resource for carrying the opposite SL dedicate resource/RS can be configured.

A fourth stage of the single SL hop beam failure recovery implemented by embodiments of the application is related to the monitoring for a failure recovery response or beam failure recovery response, BFRR, by the UE 101. After the base station 105 correctly receives the SL BFRQ, a BFRR will be transmitted as a response to the BFRQ. The BFRR can be transmitted by the base station 105 in one or more than one link including Uu/Un link, SL or their combination.

According to embodiments of the application one or more than one CORESET and/or one or more than one search space and/or one or more than one QCL assumption for SL BFRR monitoring can be configured. More than one CORESET/search space for SL BFRR monitoring can be configured. For each CORESET and/or search space, the UE 101 can make a QCL assumption based on its associated reported SL new beam/set, e.g. new beam 1 and 2 corresponding to CORESET1&2 and/or search space 1&2 respectively.

According to embodiments of the application one or more than one monitoring windows can be used.

For one monitoring window the same/separate CORESET/search space can be configured for more than one BFRR transmission according to embodiments of the application. More than one BFRR transmission can be transparent to the UE 101, and the UE 101 can make the same QCL assumption for the more than one BFRR. The monitoring window starting time can be configured or predefined e.g. starting from n+4, where n is the BFRQ transmission time for the UE 101.

For more than one monitoring window, the starting time and window duration may be predefined and/or configured according to embodiments of the application. For instance, for the exemplary case of two monitoring time windows, the first monitoring time window and the second monitoring time window can be configured or predefined in the following way.

The first monitoring window starting time can be configured or predefined in that starting from n+m, the window duration can be undefined, or predefined or configured or signaled as from m. That means the duration can be from n+4 to n+m−1.

The second monitoring window starting time can be configured or predefined in that starting from n+k, the starting time can be predefined or configured. One option is k=m or k. The window duration can be undefined, or predefined or configured.

According to embodiments of the application, for the current Uu link BFRR, the selected beam for the BFRQ can be used for BFRR PDCCH monitoring. When the BFRR transmitted in the Uu/Un link or in the 2nd SL is for the 1st SL BFRQ, the correspondence information between BFRQ and BFRR resource and/or timing should be signaled. One way is to indicate this correspondence explicitly with signaling information to the receiving device. Another way is to indicate this implicitly, for example once the device receives the BFRR from the Uu/Un link or the 2nd SL on SL DCI from PDCCH, the device will know it is for the SL BFRR.

According to further embodiments of the application, both the sidelink direction channel measurement and feedback are supported. This is helpful to enable SL data and/or control link adapted transmission, especially for unicast or groupcast transmission. The SL measurement reporting or feedback resource can be configured directly in the Uu link or through the opposite SL and another Uu link.

Alternatively, for the BFRR there can be signaling in the Uu/Un link or the SL indicating: route/link information, an intermediate device ID and/or a destination ID.

Embodiments of the application provide a SL DL/forward link beam failure recovery. According to embodiments of the application the SL DL/forward link (which is herein also referred to as first SL) can be a SL with PDCCH and/or with PDSCH and/or with CSIRS and/or with SS/PBCH a block. For simplicity, SL DL is used in the following for all these different embodiments.

A first stage of the SL DL/forward link beam failure recovery provided by embodiments of the application is related to a SL beam or link failure detection based on a SL DL signal or channel. The SL DL signal can be SL DL RS or SSB, the SL DL channel can be SL DL control channel or data channel. A threshold can be configured for SL DL beam failure detection on the SL DL channel quality. If all the measured DL signals of one set have a quality lower than the configured threshold, then beam or link failure occurs. And/or if one or more than one error occur for the channel detection or the error is higher than configured threshold, then beam or link failure occurs.

A second stage of the SL DL/forward link beam failure recovery provided by embodiments of the application is related to the identification of a new SL DL candidate beam based on the SL DL signal and/or channel. A threshold can be configured for new SL DL candidate beam identification and used after the beam failure has occurred. The SL DL signal and/or channel for the new SL candidate beam can include SL DL RS and/or SSB and/or SL control channel or data channel.

There can be two modes for the new SL candidate beam identification based on the SL signal and/or channel, namely mode 1 and mode 2.

Mode 1 concerns the case that no new qualified beam is found. In an embodiment, a report can be transmitted by the UE 101 that no new DL qualified beam has been found, that a new DL beam transmission is required and/or a DL beam sweeping is required or beam or link failure occurs. Such reporting can be mapped to dedicated resource/RS or can be carried in control or data channel contents. The report can be transmitted with mapping to Uu/Un/another SL dedicated resources/RS and/or the opposite link resources/RS and/or another Uu/Un/SL resources/RS.

Mode 2 concerns the case that a new qualified beam has been found. According to embodiments of the application, in this case the BFRQ transmission is initiated, which is described in more detail below in the context of the third stage of the SL DL/forward link beam failure recovery provided by embodiments of the application.

A third stage of the SL DL/forward link beam failure recovery provided by embodiments of the application is related to the transmission of one or more than one SL DL beam failure recovery requests, BFRQs, transmitted by the UE 101 via the Uu/Un link or SL or a combination thereof, as will be described in more detail in the following.

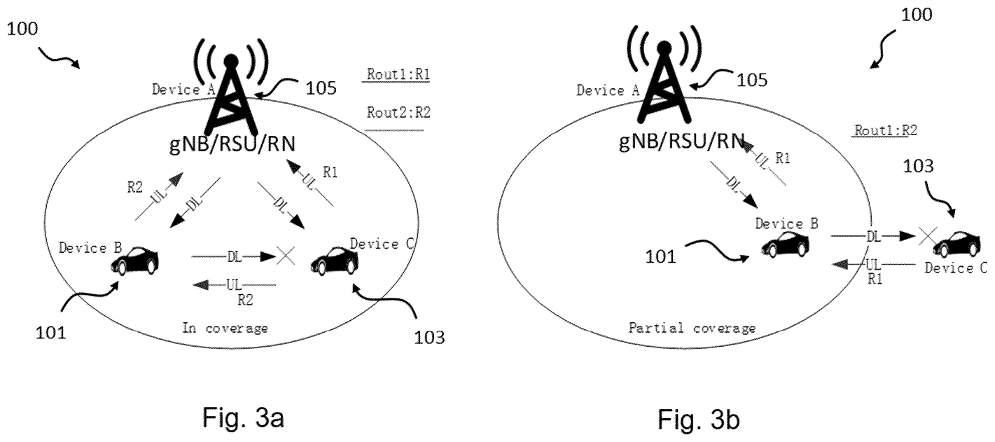

A first case, i.e. case 1, concerns the SL DL BFRQ transmitted in the first Uu/Un link or the first SL, which is illustrated in FIG. 3a (in coverage scenario). In the figure the BFRQ transmission route for this case is identified as R1. To enable fast SL beam failure recovery, RS or channel resource in device_BtoC and channel resource/RS in device_CtoA mapping or correspondance is configured or signaled or defined: Configuring the mapping or correspondence between SL DL new candidate RS and Uu/Un (or another SL) dedicated resource e.g. PRACH or RS; And/or mapping or correspondance between SL DL new candicate RS and Uu/Un (or another SL) DL RS/SSB.

A second case, i.e. case 2, concerns the transmission of the SL DL BFRQ first in the opposite SL and, subsequently, in the second Uu/Un link (or the second SL), which is illustrated in FIG. 3a (in coverage scenario) and FIG. 3b (partial coverage scenario). In the figures the BFRQ transmission route for this case is identified as R2. To enable fast and reliable SL beam failure recovery, RS in device_BtoC, channel resource/RS in device_CtoB and channel resource/RS in device_BtoA mapping or correspondance is configured or signaled or defined: Configuring the mapping or correspondance between SL DL RS and the opposite/UL SL dedicate resource/RS; Mapping or correspondance between SL UL dedicated resource/RS and Uu/Un (or another SL) dedicated resource e.g. PRACH or RS; Mapping or correspondence between SL UL dedicated resource/RS and Uu/Un (or another SL) DL RS/SSB. Or combination of some or all of the above cases.

According to embodiments of the application, a third case, i.e. case 3, can be a combination of the case 1 and case 2 described above. Supporting both case 1 and case 2 can be configured.

A fourth case, i.e. case 4, concerns the transmission of the SL DL BFRQ by control channel or data channel.

According to an embodiment, the SL BFRQ information can be transmitted by control channel or data channel in the first Uu/Un link or the first SL, as illustrated in FIG. 3a (in coverage scenario). In the figure the BFRQ transmission route for this case is identified as R1. To enable fast SL beam failure recovery, the transmission resource/channel in Uu/Un or 2nd SL is configured or signaled or defined: Configuring the transmission resource e.g. PUCCH or PUSCH for SL new candidate RS reporting.

According to an embodiment, the SL BFRQ information can be transmitted first by the UE 101 in the opposite SL via resource mapping or via control channel or data channel, and, subsequently, be transmitted in the second Uu/Un link (or the second SL) via control channel or data channel, as illustrated in FIG. 3a (in coverage scenario) and FIG. 3b (partial coverage scenario). In the figures the BFRQ transmission route for this case is identified as R2. To enable fast and reliable SL beam failure recovery, RS in device_BtoC, channel resource/RS in device_CtoB and channel resource/RS in device_BtoA is configured or signaled or defined: Configuring the mapping or correspondance between SL RS and the opposite SL dedicate resource/RS or transmit the new identified SL DL RS via SL UL control channel or data channel; Then is transmitted in the 2nd Uu/Un link (or SL) via the PUCCH or PUSCH resource for carrying the opposite SL dedicate resource/RS.

As the fourth stage of the SL DL/forward link beam failure recovery provided by embodiments of the application is virtually identical to the fourth stage of the single SL hop beam failure recovery implemented by embodiments of the application already described above, reference is made to the detailed description above.

Embodiments of the application provide a SL UL/reverse link beam failure recovery. According to embodiments of the application the SL UL/reverse link (which is herein also referred to as the opposite link of the first link) can be a SL feedback link, a SL with PUCCH and/or with PUSCH and/or with SRS and/or with PRACH, or the opposite link of the first SL. For simplicity, SL UL is used in the following for all these different embodiments.

A first stage of the SL UL/reverse link beam failure recovery provided by embodiments of the application is related to a SL beam failure detection based on a SL UL signal. The SL UL signal can be SL UL RS/preamble/PRACH or SL UL control. A threshold can be configured for SL UL beam failure detection with respect to the SL UL channel quality. If all the measured UL signals in a set have a quality lower than the configured threshold, then beam failure occurs.

A second stage of the SL UL/reverse link beam failure recovery provided by embodiments of the application is related to the identification of a new SL UL candidate beam or signal based on the SL UL signal and/or channel. A threshold can be configured for the identification of a new SL UL candidate beam or signal and used after a beam failure has occurred. The SL UL signal and/or channel for the new SL candidate beam can include SL UL RS and/or SSB and/or SL control channel or data channel.

According to embodiments of the application there can be two modes for the new SL candidate beam identification based on the SL signal and/or channel, namely mode 1 and mode 2.

Mode 1 concerns the case that no new qualified beam can be found by the UE 101. A report that no new UL qualified beam can be found, that a new UL beam transmission is required or that a UL beam sweeping is required can be transmitted. Such reporting can be mapped to dedicated resource/RS or can be carried in control or data channel content. The report can be transmitted with a mapping to Uu/Un/another SL dedicated resources/RS and/or the opposite link resources/RS and/or another Uu/Un/SL resources/RS.

Mode 2 concerns the case that a new qualified beam has been found. According to embodiments of the application, in this case the BFRQ transmission is initiated, which is described in more detail below in the context of the third stage.

A third stage of the SL UL/reverse link beam failure recovery provided by embodiments of the application is related to the transmission of one or more than one SL UL beam failure recovery request, BFRQs, transmitted in the Uu/Un link or the SL or a combination thereof, as will be described in more detail in the following.

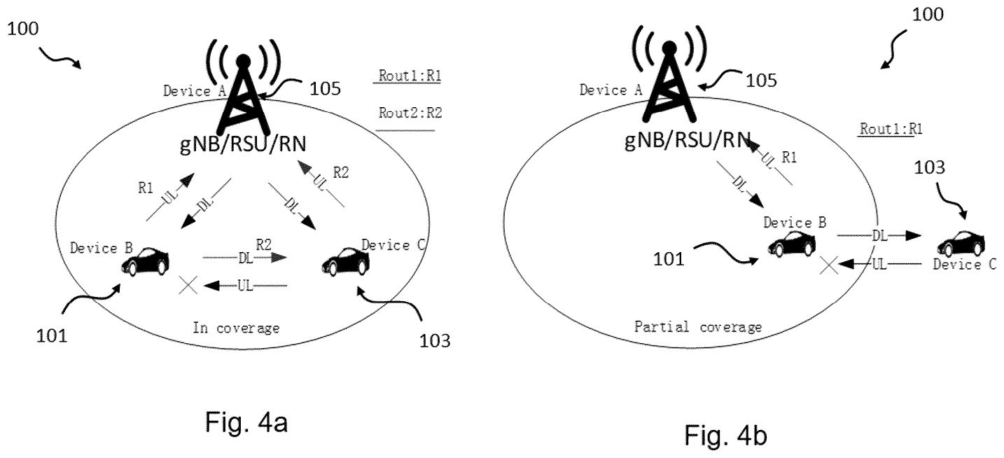

A first case, i.e. case 1, concerns the transmission of the SL UL BFRQ in the first Uu/Un link or the first SL, which is illustrated in FIGS. 4a and 4b (in coverage scenario). In the figures the BFRQ transmission route for this case is identified as R1. To enable fast SL beam failure recovery, RS in device_CtoB and channel resource/RS in device_BtoA mapping or correspondance is configured or signaled or defined: Configuring the mapping or correspondence between SL UL new candidate RS and Uu/Un (or another SL) dedicated resource e.g. PRACH or RS; And/or mapping or correspondance between SL UL new candicate RS and Uu/Un (or another SL) DL RS/SSB.

A second case, i.e. case 2, concerns the transmission of the SL UL BFRQ first via the opposite SL and, subsequently, via the second Uu/Un link (or the second SL), as illustrated in FIG. 4a (in coverage scenario). In the figure the BFRQ transmission route for this case is identified as R2. To enable fast and reliable SL beam failure recovery, RS in device_CtoB, channel resource/RS in device_BtoC and channel resource/RS in device_CtoA mapping or correspondance is configured or signaled or defined: Configuring the mapping or correspondance between SL UL RS and the opposite/DL SL dedicate resource/RS; Mapping or correspondance between SL DL dedicated resource/RS and Uu/Un (or another SL) dedicated resource e.g. PRACH or RS; Mapping or correspondence between SL DL dedicated resource/RS and Uu/Un (or another SL) DL RS/SSB. Or combination of some or all of the above cases.

According to embodiments of the application, a third case, i.e. case 3, can be a combination of the case 1 and case 2 described above. Supporting both case 1 and case 2 can be configured.

A fourth case, i.e. case 4, concerns the transmission of the SL UL BFRQ information by control channel or data channel.

According to an embodiment, the SL BFRQ information can be transmitted by control channel or data channel in the first Uu/Un link or the first SL, as illustrated in FIG. 4a (in coverage scenario) and FIG. 4b (partial coverage scenario). In the figure the BFRQ transmission route for this case is identified as R1. To enable fast SL beam failure recovery, the transmission resource/channel in Uu/Un or 2nd SL is configured or signaled or defined: Configuring the transmission resource e.g. PUCCH or PUSCH for SL new candidate RS reporting.

According to an embodiment, the SL BFRQ is first transmitted in the opposite SL via resource mapping or via control channel or data channel, and then in the second Uu/Un link (or the second SL) via control channel or data channel, as illustrated in FIG. 4a (in coverage scenario) and FIG. 4b (partial coverage scenario). In the figure the BFRQ transmission route for this case is identified as R2. To enable fast and reliable SL beam failure recovery, RS in device_BtoC, channel resource/RS in device_CtoB and channel resource/RS in device_BtoA is configured or signaled or defined: Configuring the mapping or correspondance between SL RS and the opposite SL dedicate resource/RS or transmit the new identified SL UL RS via SL DL control channel or data channel; Then is transmitted in the 2nd Uu/Un link (or SL) via the PUCCH or PUSCH resource for carrying the opposite SL dedicate resource/RS.

According to another embodiment, both sidelink UL channel measurement and feedback can be supported by the UE 1o1. This is helpful to enable SL UL data and/or control link adapted transmission. The SL UL measurement reporting or feedback can be configured to be transmitted directly in the Uu link or another sidelink or through the opposite SL and then another Uu link or a third sidelink.

As the fourth stage of the SL UL/reverse link beam failure recovery provided by embodiments of the application is virtually identical to the fourth stage of the single SL hop beam failure recovery implemented by embodiments of the application already described above, reference is made to the detailed description above.

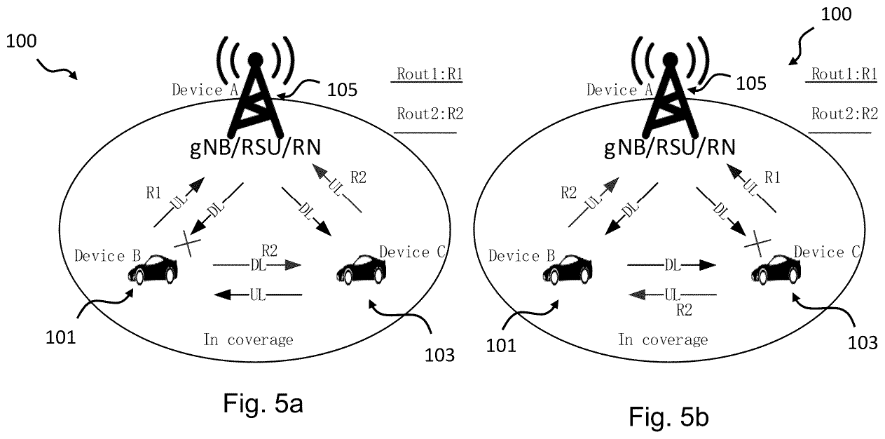

As will be described in the following under further reference to FIGS. 5a and 5b, embodiments of the application provide a solution for a Uu or Un link (or the first SL) beam failure recovery via SL (or the second SL). As will be appreciated, the Uu link is generally used between the base station or RSU 105 (e.g. gNB or RSU 105) and the UE 101, 103, while the Un link is usually used between the base station 105 and a relay or between relays (sometimes also called backhaul link), the sidelink is sometimes used between the RSU or UE 105 (e.g. RSU or UE 105). For simplicity, in the following description the Uu will be taken as an example with the understanding that the following description applies to the Uu link of the first SL as well.

As already described in the background section above, the conventional system only supports Uu UL based BFRQ transmission, when there is a Uu DL beam failure detected. However, there may be the case that the beam failure also occurs for the Uu UL. Then the BFRQ will not be successfully transmitted in the Uu UL which will cause additional delay or even packet loss. As will be described in more detail in the following, SL can be used also for Uu link beam and/or failure recovery according to embodiments of the application, which advantageously help to improve Uu link reliability and reduce the latency. The above description also applies to the case when there is only the first SL.

A first stage of the Uu link beam failure recovery provided by embodiments of the application is related to a Uu link beam or link failure detection based on a Uu DL signal. The Uu DL signal can be a Uu DL RS or SSB or both. A threshold can be configured for Uu DL beam or link failure detection based on the Uu DL channel quality. If all the measured DL signals in a set have a quality lower than the configured threshold, then a beam or link failure occurs. And/or if one or more than one error occur for the channel detection or the error is higher than configured threshold, then beam or link failure occurs.

A second stage of the Uu link beam failure recovery provided by embodiments of the application is related to the identification of a new Uu DL candidate beam based on the Uu DL signal and/or channel. A threshold can be configured for the new Uu DL candidate beam identification and used after a beam failure has occurred. The Uu DL signal and/or channel for the new SL candidate beam or signal can include SL DL RS and/or SSB.

A third stage of the Uu link beam failure recovery provided by embodiments of the application is related to the following different cases, when no new qualified beam can be found by the UE 101.

According to a first alternative only a Uu link based BFRQ transmission and BFRR can be used, which is similar as the current Uu link behavior.

According to a second alternative, a SL assisted Uu BFRQ transmission can be used by the UE 101 with further embodiments defined by the following cases.

In a first case, i.e. case 1, the Uu link BFRQ can be transmitted via SL signal with resource mapping. The resource mapping can be configured or signaled or defined between the Uu link and the SL: Mapping among the first Uu/Un or SL RS/SSB and the second SL dedicate resource/RS and the third Uu link or sidelink dedicate resource/RS. According to embodiments of the application the mapping can further include a mapping between the first Uu/Un/SL RS/SSB and the second SL dedicated resource e.g. RS/SSB/PRACH/PUSCH/PUCCH/PDCCH/PDSCH resource (the RS can be e.g. SRS, CSIRS, DMRS, or PTRS). Additionally or alternatively, the mapping can include a mapping between the second SL dedicated resources and the third Uu/Un/SL dedicated resources e.g. RS/SSB/PRACH/PUSCH/PUCCH/PDCCH/PDSCH resource (the RS can be e.g. SRS, CSIRS, DMRS, or PTRS).

In a second case, i.e. case 2, the Uu link BFRQ is transmitted via the SL channel. In other words, the new identified beam information or BFRQ can also be carried in the SL channel. The SL channel can include PUSCH/PUCCH/PDCCH/PDSCH and the like. Then the new identified beam information can be carried in the third Uu link channel as the channel information to the base station 105. The channel can include PUSCH/PUCCH/PDCCH/PDSCH or the like.

In a third case, i.e. case 3, the Uu link BFRQ is transmitted via the SL channel (or resource mapping) and the Uu link channel (or resource mapping), i.e. a combination of case 1 and case 2 above.

More specifically, the first Uu link BFRQ can be transmitted first in the second SL via resource mapping between the first Uu link RS or SSB and the second SL dedicated resource. Subsequently, the BFRQ information can be transmitted in the third Uu link via the Uu link channel e.g. as control information or data information.

Alternatively, the first Uu link BFRQ can be transmitted first in the second SL via the SL channel. Subsequently, the BFRQ information can be transmitted in the third Uu link via resource mapping between the third Uu link RS or SSB or PRACH and the second SL relayed BFRQ information.

The above case also applies when all are SL or part of SL. For example among the first SL, second SL and third SL. The first SL and third SL correspond to the first and second Uu link above.

A fourth stage of the Uu link beam failure recovery provided by embodiments of the application is related to BFRR monitoring. After the base station 105 correctly receives one or more BFRQs, the BFRR will be transmitted as a response to the BFRQ. As will be appreciated, the BFRR for the Uu/Un or the first SL is generally different from the BFRR used for the conventional Uu link failure recovery scheme.

According to embodiments of the application, the UE 101 may monitor one or more BFRRs transmitted from the base station 105 in one or more than one CORESET and/or one or more than one search space and/or with more than one QCL assumption.

When there is only Uu BFRQ, it is similar as the current Uu/Un BFRR behavior.

When there is a SL assisted or involved BFRQ transmission, as provided by embodiments of the application, there can be two CORESETs, each with one QCL assumptions. The first CORESET can be based on a first QCL assumptions corresponding to the first BFRQ, while the second CORESET can be based on the second QCL assumption corresponding to the second BFRQ. For each CORESET/search space, the UE 101 can assume a QCL based on its associated reported Uu/Un link or sidelink new CSI-RS or SSB (or SL new RS or SSB), e.g. new beam 1 and 2 (RS or SSB) corresponding to first and second CORESET.

For only one monitoring window, the same/separate CORESET/search space can be configured for more than one BFRR transmission. More than one BFRR transmission can be transparent to the 101 UE, and the UE 101 can make the same QCL assumption for the other BFRRs. Alternatively, the separate CORESET/search space can be configured for more than one BFRR transmission. A correspondence between the CORESET/search space and the reporting new RS/SSB is defined or configured. A respective QCL assumptions are made based on the reported RS/SSB and the correspondence. The starting time value of one window can be predefined e.g. n+4 or configured.

For more than one monitoring windows, both the starting time and duration can be configured/signaled. Alternatively, the starting time of the first window can be predefined, while the starting time of the second window is configured/signaled. In an embodiment, the duration of the first window can depend on the starting time of the second window. For example: First window: start from n+4 with window length e.g. from n+4˜n+k−1; Second window: start from n+k with configured window length.

According to embodiments of the application, the Uu/Un/SL monitoring window can correspond to the dedicated Uu/Un resources rather than the absolute time.

Once one BFRR in the configured CORESET has been decoded successfully, according to an embodiment the UE 101 can stop using another QCL assumption for BFRR monitoring.

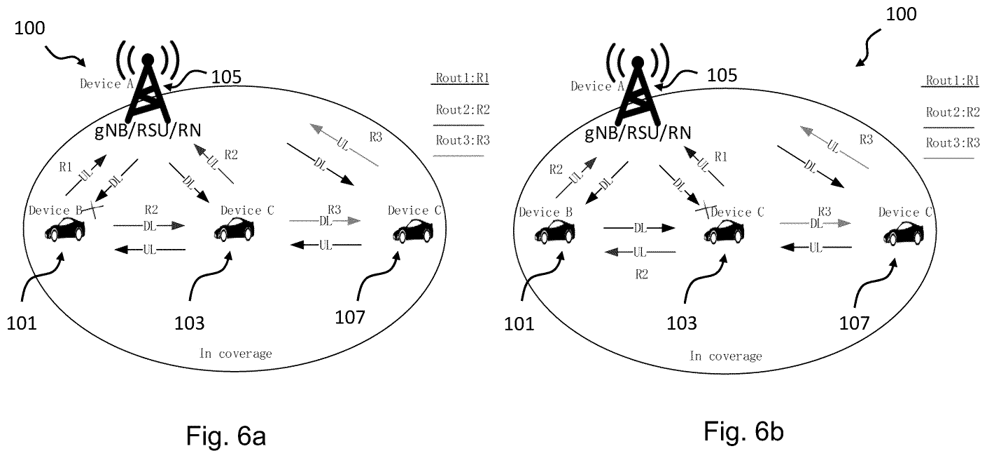

As will be described in the following under further reference to FIGS. 6a and 6b, embodiments of the application provide a solution for extending the beam failure recovery for SL or Uu/Un to multiple hops or links. In other words, the beam or link recovery can be through more than one Uu/Un link and/or SL. According to embodiments of the application a first, second and fourth stage of such a multi hop/link beam failure recovery for SL or Uu/Un are virtually identical to the to the corresponding first, second and fourth stage of the single SL hop beam failure recovery implemented described above. Thus, only the third stage of the multi hop/link beam failure recovery for SL or Uu/Un will be described in the following in more detail.

In a first case, i.e. case 1, of the third stage of the multi hop/link beam failure recovery for SL or Uu/Un implemented by embodiments of the application a resource mapping among multiple links for BFRQ can be configured, defined and/or signaled.

In a second case, i.e. case 2, of the third stage of the multi hop/link beam failure recovery for SL or Uu/Un implemented by embodiments of the application the BFRQ can be configured to be transmitted in the channels of multiple links.

In a second case, i.e. case 2, the above cases 1 and 2 can be combined. In other words, according to embodiments of the application the BFRQ can be configured to be transmitted in resource mapping between or among links and in channels of one or more than one link. For instance, the UE 101 is configured with or signaled a mapping between Uu/Un/SL DL CSIRS/SSB and/or UL dedicated resources for BFRQ with: SL dedicated DL resources/RS; SL dedicated UL resources/RS; another Uu/Un/SL dedicated DL resources/RS; and/or another Uu/Un/SL dedicated UL resources/RS.

According to an embodiment, the BFRQ information can be carried along with the mapping to resources and/or in the channel as channel information. The base station 105 can select/configure the link within the multi-hop for BFRQ transmission.

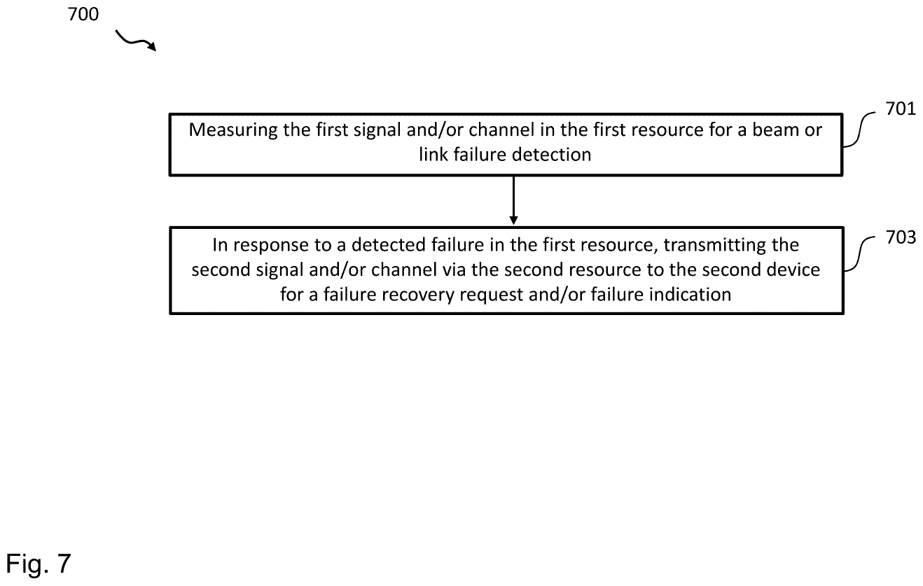

FIG. 7 is a flow diagram illustrating operations of a method 700 of operating the user equipment 101 according to an embodiment. The method 700 comprises the operations of measuring the first signal and/or channel in the first resource for a beam or link failure detection; and, in response to a detected failure in the first resource, transmitting the second signal and/or channel via the second resource to the second device for a failure recovery request.

Thus, embodiments of the application provide a new signal or RS type for beam failure detection and new candidate beam identification. More specifically, SL/Un UL RS can be used as RS for SL/Un link beam failure detection or both direction of SL signal for SL beam failure detection and new candidate beam identification.

Moreover, embodiments of the application provide a UE reporting mode selection based on beam failure detection. According to a first mode, i.e. mode 1, no new qualified beam can be found. A report that that no new qualified beam can be found, that a new beam transmission is required and/or that a beam sweeping is required can be transmitted. Such reporting can be mapped to dedicated resource/RS or can be carried in control or data channel content. According to a second mode, i.e. mode 2, no new qualified beam can be found, and a BFRQ transmission is initiated.

Moreover, embodiments of the application enable a configuration of BFRQ in Uu/Un, a SL resource correspondence/mapping signaling across links between a new identified beam RS and the BFRQ transmission resource. More specifically, embodiments of the application allow to configure one or more than one link among multiple links for one or more than one BFRQ transmission, wherein the link includes the SL, Uu, or Un link, and each link can be more than one link. Embodiments of the application provide a mapping between SL new candidate RS and Uu/Un (or another SL) dedicated resource including Uu DL/UL or both DL&UL e.g. typically PRACH or DL RS or SSB. Embodiments of the application provide a mapping between SL new candidate RS and the opposite SL dedicate resource/RS (e.g. DL to UL, UL to DL or both). Embodiments of the application provide a mapping between SL dedicated resource/RS and the second Uu/Un (or another SL) dedicated resource including DL/UL or both e.g. typically PRACH or DL RS or SSB. For cross link transmission, the new identified beam information can also be carried in the dedicated channel. Both BFRQ and dedicated resource mapping and BFRQ carrying in channel can be enabled in different links.

Moreover, embodiments of the application provide for a monitoring of a BFRR by the UE 101, in response to a BFRQ. According to embodiments of the application, the UE 101 can use more than one CORESET and/or one or more than one QCL assumptions for Uu/Un/SL BFRR monitoring. A separate CORESET/search space can be used for BFRR monitoring. For each CORESET/search space, the UE 101 can make a QCL assumption based on its associated BFRQ reported Uu/Un/SL new beam/new SL CSI-RS/SSB, e.g. new beam 1 and 2 corresponding to a first and second CORESET, respectively. One or more than one monitoring time window can be used by the UE 101 for BFRR monitoring. In case of only one window, e.g. n+k1+k2 (k1 can be predefined e.g. 4 or 8) and k2 can be configured. In case of two or more windows, the starting time of the first window can predefined, while the starting time of the second window can be configured/signaled. The duration of the first window can depend on the starting time of the second window. In an embodiment, the Uu/Un/SL monitoring window can correspond to the timing of the dedicated Uu/Un/SL resources rather than absolute time. Once a BFRR CORESET has been decoded successfully, the UE 101 can stop using another QCL assumption for BFRR monitoring.

Thus, according to embodiments of the application the UE 101 is configured to: determine whether a beam failure and/or link failure occurs (and/or received signal quality and/or received signal to noise ratio and/or received signal to noise and interference is lower than certain threshold, or one or more than error occurs or above certain configured threshold) based on the detection of a received signal and/or a received channel; and transmit a signal and/or channel and/or a message in the second resource and/or link if a beam failure or link failure occurs in the first resource and/or link.

According to embodiments of the application, the detected received signal is a DL signal and/or an UL signal or a sidelink signal or a sidelink DL signal and/or sidelink UL signal and/or an Un UL signal and/or an Un DL signal and/or an Uu UL signal and/or an Uu DL signal.

According to embodiments of the application, the transmitted signal and/or channel and/or message can indicate that no qualified beam/link has been found, that a new beam/link transmission is required, that a beam sweeping is required, and/or that a new qualified beam and/or reference signal and/or SSB is required, and/or beam or link failure occurs.

According to embodiments of the application, a mapping or correspondence is predefined or received by the UE 101 indicating the resource and/or signal correspondence between or across links and/or resources.

For the further, i.e. second UE 103 a mapping or correspondence can be predefined or received by the second UE 103, wherein the mapping or correspondence indicates the resource and/or signal and/or channel correspondence between the fourth received link and/or resource and/or signal and/or channel and the first transmitted link and/or resource and/or signal and/or channel and/or between the fourth received link and/or resource and/or signal and/or channel and the second received link and/or resource and/or signal and/or channel and/or between the third transmitted link and/or resource and/or signal and/or channel and the fourth received link and/or resource and/or signal and/or channel.

Alternatively or additionally, a mapping or correspondence can be predefined or received by the second UE 103, wherein the mapping or correspondence indicates the resource and/or signal and/or channel correspondence between the third received link and/or resource and/or signal and/or channel and the fifth transmitted link and/or resource and/or signal and/or channel and/or between the third received link and/or resource and/or signal and/or channel and the sixth received link and/or resource and/or signal and/or channel and/or between the link between the first UE 101 and the second UE 103 and the link between the first UE 101 and the base station 105 and/or the link between the first UE 101 and the second UE 103 and the link between the second UE 103 and the base station 105.

According to embodiments of the application, the first transmitted link, the second received link, the fifth transmitted link and the sixth received link can be Uu link or Un link or SL.

Additionally or alternatively, the third transmitted link, the fourth received link, the third received link and the fourth transmitted link can be a SL.

Additionally or alternatively, the first and fifth transmitted link are a forward SL, the second and the sixth received link are a reverse SL, the third transmitted or received link is a forward SL, and the fourth transmitted or received link is a reverse SL.

Additionally or alternatively, the first and fifth transmitted link are a forward SL, the second and the sixth received link are a reverse SL, the third transmitted or received link is a reverse SL, and the fourth transmitted or received link is a forward SL.

According to embodiments of the application signaling is predefined or received that indicates for the first UE 101 the first transmitted link and/or resource channel configuration for the BFRQ transmission of the fourth received link and/or resource and/or signal.

Additionally or alternatively, the signaling can indicate for the first UE 101 the resource and/or signal correspondence between the third transmitted link and/or resource and/or signal and the fourth received link and/or resource and/or signal.

Additionally or alternatively, the signaling can indicate for the first UE 101 the fourth received link and/or resource channel configuration for the BFRQ transmission of the third transmitted link and/or resource and/or signal.

Additionally or alternatively, the signaling can indicate for the first UE 101 the fourth received link and/or resource channel configuration for the BFRQ transmission of the sixth received link and/or resource and/or signal.

Additionally or alternatively, the signaling can indicate for the first UE 101 the resource and/or signal correspondence between the fourth received link and/or resource and/or signal and the sixth received link and/or resource and/or signal.

According to embodiments of the application signaling is predefined or received that indicates for the second UE 103 the fifth transmitted link and/or resource channel configuration for the BFRQ transmission of the third received link and/or resource and/or signal.

Additionally or alternatively, the signaling can indicate for the second UE 103 the resource and/or signal correspondence between the third received link and/or resource and/or signal and the fourth received link and/or resource and/or signal.

Additionally or alternatively, the signaling can indicate for the second UE 103 the fourth transmitted link and/or resource channel configuration for the BFRQ transmission of the third received link and/or resource.

Additionally or alternatively, the signaling can indicate for the second UE 103 the fourth transmitted link and/or resource channel configuration for the BFRQ transmission of the second received link and/or resource.

Additionally or alternatively, the signaling can indicate for the second UE 103 the resource and/or signal correspondence between the third received link and/or resource and/or signal and the second received link and/or resource and/or signal.

According to embodiments of the application, the first transmitted link, the second received link, the fifth transmitted link and the sixth received link can be a Uu link or a Un link or a SL.

Alternatively or additionally, the third transmitted link, the fourth received link, the third received link and the fourth transmitted link can be a SL.

Alternatively or additionally, the first and fifth transmitted link can be a forward SL, the second and the sixth received link can be a reverse SL, the third transmitted or received link can be a forward SL, and the fourth transmitted or received link can be a reverse SL.

Alternatively or additionally, the first and fifth transmitted link can be a forward SL, the second and the sixth received link are a reverse SL, the third transmitted or received link is a reverse SL, and the fourth transmitted or received link is a forward SL.

Moreover, according to embodiments of the application the UE 101 is configured to receive the configuration of more than one CORESET and/or more than one QCL assumption for Uu/Un/SL BFRR monitoring. A separate CORESET/search space can be used by the UE 101 for BFRR monitoring. For each CORESET/search space, the UE 101 can make a QCL assumption based on its associated BFRQ reported Uu/Un/SL new beam/new SL CSI-RS/SSB. One or more than one monitoring windows for BFRR can be predefined or configured.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the application beyond those described herein. While the present application has been described with reference to one or more particular embodiments, those skilled in the art recognize that many changes may be made thereto without departing from the scope of the present application. It is therefore to be understood that within the scope of the appended claims and their equivalents, the application may be practiced otherwise than as specifically described herein.

1. A user equipment, comprising:
at least one processor configured with processor-executable instructions to cause the user equipment to perform operations including:
measuring a first signal or channel in a first resource for a beam or link failure detection, wherein the user equipment is configured to communicate using the first signal or channel via the first resource with a first user equipment and using a second signal or channel via a second resource with a second user equipment; and
in response to a detected failure in the first resource:
selecting the second resource for the second signal or channel based on the first resource for the first signal or channel and a correspondence between the first resource and the second resource;
transmitting the second signal or channel via the second resource to the second user equipment for a failure recovery request or a failure indication, wherein the failure recovery request is configured to trigger the second user equipment to transmit the failure recovery request to a base station via a third resource, the first resource, the second resource, and the third resource being different from one another, and wherein the user equipment, the first user equipment, and the second user equipment are different from one another; and
monitoring a failure recovery response in a different search space or a different control resource set (CORESET) based on same antenna port quasi-collocation parameters respectively with more than one reference signal (RS) or synchronization signal (SS) indicated by the second signal or channel via the second resource.

2. The user equipment according to claim 1, wherein the first resource is a first sidelink resource between the user equipment and the first user equipment, and wherein the second resource is a second sidelink resource between the user equipment and the second user equipment.

3. The user equipment according to claim 1, the operations further comprising:
detecting a beam failure or a link failure that has occurred based on a radio link quality being smaller than a first threshold value or based on one or more errors having occurred for a channel detection.

4. The user equipment according to claim 3, wherein the radio link quality is a signal strength of one or more RSs or an SS/Physical Broadcast Channel (PBCH) block (SSB).

5. The user equipment according to claim 1, the operations further comprising:
in response to the detected failure in the first resource, determining a new signal resource or a new beam for communicating with the first user equipment based on one or more RSs or an SSB in a first set or in a second set received from the first user equipment.

6. The user equipment according to claim 1, wherein the second signal or channel provides an indication that no new beam or no new signal resource for communicating with the first user equipment has been determined, or an indication that the new signal resource is required, or an indication that a beam sweeping is required based on the user equipment being unable to determine the new beam or the new signal resource for communicating with the first user equipment.

7. The user equipment according to claim 1, the operations further comprising:
receiving, in response to transmission of the failure recovery request based on the second signal or channel, the failure recovery response, wherein the failure recovery request comprises a beam failure recovery request (BFRQ), and wherein the failure recovery response comprises a beam failure recovery response (BFRR).

8. The user equipment according to claim 1, wherein the beam or link failure is of a sidelink resource in a first direction, the operations further comprising:
transmitting a second failure recovery request via the sidelink resource in a second direction to the second user equipment.

9. The user equipment according to claim 8, wherein the second failure recovery request indicates to the second user equipment to transmit or forward the second failure recovery request to the base station via the third resource in a third communication link between the second user equipment and the base station.

10. A communication method, comprising:
measuring, by a user equipment, a first signal or channel in a first resource for a beam or link failure detection, wherein the user equipment is configured to communicate using the first signal or channel via the first resource with a first user equipment and using a second signal or channel via a second resource with a second user equipment; and
in response to a detected failure in the first resource:
selecting, by the user equipment, the second resource for the second signal or channel based on the first resource for the first signal or channel and a correspondence between the first resource and the second resource;
transmitting, by the user equipment, the second signal or channel via the second resource to the second user equipment for a failure recovery request or a failure indication, wherein the failure recovery request is configured to trigger the second user equipment to transmit the failure recovery request to a base station via a third resource, the first resource, the second resource, and the third resource being different from one another, and wherein the user equipment, the first user equipment, and the second user equipment are different from one another; and
monitoring, by the user equipment, a failure recovery response in a different search space or a different control resource set (CORESET) based on same antenna port quasi-collocation parameters respectively with more than one reference signal (RS) or synchronization signal (SS) indicated by the second signal or channel via the second resource.

11. The communication method according to claim 10, wherein the first resource is a first sidelink resource between the user equipment and the first user equipment, and wherein the second resource is a second sidelink resource between the user equipment and the second user equipment.

12. The communication method according to claim 10, further comprising:
detecting a beam failure or a link failure that has occurred based on a radio link quality being smaller than a first threshold value or based on one or more errors having occurred for a channel detection.

13. The communication method according to claim 12, wherein the radio link quality is a signal strength of one or more RSs or an SS/Physical Broadcast Channel (PBCH) block (SSB).

14. The communication method according to claim 10, further comprising:
in response to the detected failure in the first resource, determining a new signal resource or a new beam for communicating with the first user equipment based on one or more RSs or an SSB in a first set or in a second set received from the first user equipment.

15. The communication method according to claim 10, wherein the second signal or channel provides an indication that no new beam or no new signal resource for communicating with the first user equipment has been determined, or an indication that the new signal resource is required, or an indication that a beam sweeping is required based on the user equipment being unable to determine the new beam or the new signal resource for communicating with the first user equipment.

16. The communication method according to claim 10, further comprising:
receiving, in response to transmission of the failure recovery request based on the second signal or channel, the failure recovery response, wherein the failure recovery request comprises a beam failure recovery request (BFRQ), and wherein the failure recovery response comprises a beam failure recovery response (BFRR).

17. The communication method according to claim 10, wherein the beam or link failure of a sidelink resource in a first direction, the method further comprising:
transmitting a second failure recovery request via the sidelink resource in a second direction to the second user equipment.

18. The communication method according to claim 17, wherein the second failure recovery request indicates to the second user equipment to transmit or forward the second failure recovery request to the base station via the third resource in a third communication link between the second user equipment and the base station.

19. A non-transitory computer-readable medium having instructions stored thereon that, when executed by a user equipment, cause the user equipment to perform operations, the operations comprising:
measuring a first signal or channel in a first resource for a beam or link failure detection, wherein the user equipment is configured to communicate using the first signal or channel via the first resource with a first user equipment and using a second signal or channel via a second resource with a second user equipment; and
in response to a detected failure in the first resource:
selecting the second resource for the second signal or channel based on the first resource for the first signal or channel and a correspondence between the first resource and the second resource;
transmitting the second signal or channel via the second resource to the second user equipment for a failure recovery request or a failure indication, wherein the failure recovery request is configured to trigger the second user equipment to transmit the failure recovery request to a base station via a third resource, the first resource, the second resource, and the third resource being different from one another, and wherein the user equipment, the first user equipment, and the second user equipment are different from one another; and
monitoring a failure recovery response in a different search space or a different control resource set (CORESET) based on same antenna port quasi-collocation parameters respectively with more than one reference signal (RS) or synchronization signal (SS) indicated by the second signal or channel via the second resource.
